(19) United States
(12) Patent Application Publication
(10) Pub. No.: US 2011/0270702 A1
(43) Pub. Date: Nov. 3, 2011

(54) DYNAMIC UNIT-DEMAND AUCTION

(76) Inventors: Charles Gregory Plaxton, Austin, TX (US); Chinmayi Krishnappa, Austin, TX (US)

(21) Appl. No.: 13/100,141

(22) Filed: May 3, 2011

Related U.S. Application Data
(60) Provisional application No. 61/330,448, filed on May 3, 2010.

(51) Int. Cl. G06Q 30/00

(52) U.S. Cl. 705/26.3

(57) ABSTRACT

Systems and methods provide for a dynamic unit-demand auction that can support bid revision. Preparation of a unit-demand bid can involve specifying offers for multiple items, thus a unit-demand agent can intend to modify one or more components of an active bid. Embodiments of the system and methods provide a comprehensive solution to unit-demand bid revision problem including satisfying strong theoretical properties related to efficiency, truthfulness, privacy preservation, and scalability, and permitting various degrees of time performance.

### CROSS-REFERENCE TO RELATED APPLICATION

This patent application is related to and claims priority from U.S. Provisional Patent Application No. 61/330,448, entitled “METHOD AND SYSTEM FOR A DYNAMIC UNIT-DEMAND AUCTION” and filed on May 3, 2010, which is incorporated by reference herein in its entirety.

### GOVERNMENT SUPPORT CLAUSE

This invention was made with government support under CCF-0635203 awarded by the National Science Foundation. The government has certain rights in the invention.

### BACKGROUND

Consider an auction in which many different items are for sale. Assume that a bidding agent assigns a separate value to each item, and is interested in acquiring at most one item. Such an agent is said to have unit-demand preferences. In a unit-demand auction, the bid of an agent takes the same form as a unit-demand preference function: The agent specifies an offer for each item, with the understanding that the bid can win at most one item. Typical online auction houses do not support such unit-demand bids. Instead, if many items are to be sold, each is sold in a separate auction. The resulting sequence of single-item auctions forces an agent with unit-demand preferences to guess whether or not to bid on each successive item, since the agent does not know the eventual selling prices of the remaining items. This guesswork degrades the efficiency of the allocation of items to agents, where the efficiency of an allocation is defined as the sum, over all items v, of the value assigned to v by the agent to which v is allocated. The main reason to contemplate selling many items within a single unit-demand auction, or indeed within any form of combinatorial auction, is to reduce the need for such guesswork, thereby enhancing efficiency. By improving efficiency, one has the potential to improve the quality of the outcome for both buyers and sellers alike.

### SUMMARY

Described herein are a set of rules for running a unit-demand auction that can be implemented in a computer system or computing device (mobile or otherwise). One embodiment of the unit-demand auction is dynamic, meaning that the unit-demand auction proceeds in rounds. In each round, new bid data (bid revision requests, and new bids) is received, and an update rule is applied to adjust the tentative solution (allocation and pricing). The tentative solution is made public at the end of each round. The update rule associated with an embodiment of the present invention is shown to satisfy a number of desirable mathematical properties. These properties make the proposed auction attractive for practical use.

One feature of an embodiment of the dynamic unit-demand auction is its support for arbitrary bid revision by tentatively allocated agents. Unit-demand bids are more expressive than the single-item bids of traditional auctions, and bid formulation is correspondingly more complex. Accordingly, there is a significant chance that a tentatively allocated agent may wish to revise one or more bid components. If a unit-demand auction imposes undue constraints on bid revision, or if the semantics of bid revision introduce additional strategic considerations, then agents may be reluctant to submit unit-demand bids. Such an artificial reduction in the number of bids undercuts the main value proposition of unit-demand auctions, e.g., improved efficiency.

Described herein is a specification of the input-output behavior of one embodiment of a proposed unit-demand auction. Section 2 introduces some relevant terminology. Section 3 describes a sequence of three sealed-bid (i.e., single round) unit-demand auctions, which are referred to herein as Auction SB1, Auction SB2, and Auction SB3. Section 4 describes an embodiment of a proposed unit-demand auction in terms of Auction SB3. Section 5 describes certain variants of the proposed auction of Section 4.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates an exemplary method for conducting a dynamic unit-demand auction in accordance with aspects of the subject disclosure.

FIG. 2 illustrates an exemplary method for updating a round in a dynamic unit-demand auction in accordance with aspects of the subject disclosure.

FIG. 3 illustrates an exemplary method for conducting a dynamic unit-demand auction in accordance with aspects of the subject disclosure.

FIG. 4 illustrates an exemplary method for conducting a single-item auction with dynamic pricing in accordance with aspects of the subject disclosure.

FIG. 5 illustrates a block diagram of an exemplary operating environment for performing the disclosed methods in accordance with aspects of the subject disclosure.

FIG. 6-7 illustrate high-level block diagrams of exemplary auction platforms which can operate in accordance with aspects of the subject disclosure.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance can or cannot occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

As employed in this specification and annexed drawings, the terms “unit,” “interface,” “system,” “platform,” and the like are intended to include a computer-related entity or an entity related to an operational apparatus with one or more specific functionalities, wherein the computer-related entity or the entity related to the operational apparatus can be either hardware, a combination of hardware and software, software, or software in execution. One or more of such entities are also referred to as “functional elements.” As an example, a unit may be, but is not limited to being, a process running on a processor, a processor, an object, an executable computer program, a thread of execution, a program, a memory (e.g., a hard disc drive or other computer-readable storage medium), and/or a computer. As another example, a unit can be an apparatus with specific functionality provided by mechanical parts operated by electric or electronic circuitry which is operated by a software or a firmware application executed by a processor, wherein the processor can be internal or external to the apparatus and executes at least a part of the software or firmware application. In addition or in the alternative, a unit can provide specific functionality based on physical structure or specific arrangement of hardware elements. As yet another example, a unit can be an apparatus that provides specific functionality through electronic functional elements without mechanical parts, the electronic functional elements can include a processor therein to execute software or firmware that provides at least in part the functionality of the electronic functional elements. An illustration of such apparatus can be control circuitry, such as a programmable logic controller. The foregoing example and related illustrations are but a few examples and are not intended to be limiting. Moreover, while such illustrations are presented for a unit, the foregoing examples also apply to a component, a system, a platform, and the like. It is noted that in certain embodiments, or in connection with certain aspects or features thereof, the terms “unit,” “system,” “interface,” “platform” can be utilized interchangeably.

Disclosed are units that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems can take the form of a computer program product on a computer-readable storage medium having computer-readable program instructions (e.g., computer software) embodied in the storage medium. More particularly, yet not exclusively, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### 1. Introduction

In a unit-demand auction, a bid specifies how much an agent is willing to pay for each of a number of items, with the understanding that the agent does not wish to acquire more than one item. A sealed-bid unit-demand auction takes in a collection of such bids and determines an allocation and pricing of the items.

Certain traditional dynamic unit-demand auctions can include an “exact” auction and an “approximate” auction. In each round, the exact auction elicits the demand (or set of preferred items at the current prices) of each agent. If there is an overdemanded set of items, a minimal overdemanded set is found, and the prices of all items in the set are incremented by one. In the alternative, if no overdemanded set can be found, the exact auction terminates and each item is allocated to an agent who demands it. It should be appreciated that the exact auction implicitly supports a limited form of bid revision: An agent is free to revise its unit-demand bid as long as the demands specified in all preceding rounds remain consistent with the revision.

Conventionally, the approximate dynamic unit-demand auction addresses such highly restrictive nature of the form of bid revision permitted by the exact auction. Similarly to the exact auction, the approximate dynamic unit-demand auction is an ascending-price auction. In the approximate dynamic unit-demand auction, agents that are not tentatively allocated are consulted in round-robin order and given the opportunity to either select an item or pass (e.g., refrain from bidding). If an unallocated agent u selects an item v, the tentative price of item v is increased by a parameter δ, and the tentative allocation is updated to reflect that item v is allocated to the agent u. The approximate dynamic unit-demand auction terminates when all of the unallocated agents pass.

Traditional approximate auctions have several shortcomings in comparison with the dynamic unit-demand auctions of the subject disclosure. For example, the auctioneer in a traditional approximate auction is required to specify a value for the parameter δ. For another example, the outcome of a traditional approximate auction can only be guaranteed to be approximately efficient or approximately truthful, even in the absence of bid revision. For yet another example, there is a tradeoff between the quality of approximation(s) that permit conducting a traditional approximate auction and the running time of an algorithm for implementing such an auction. For still another example, bid revision frameworks afforded by a traditional approximate auction generally are restrictive, since such an auction fails to allow for trading of items between tentatively allocated agents.

Other conventional dynamic unit-demand auctions can be descending price auctions that correspond to either the exact or the approximate auctions described hereinbefore. In addition, various conventional dynamic auction that generalize unit-demand auctions are available, including dynamic auctions for homogeneous and heterogeneous commodities embodying the auctioned items.

Certain conventional dynamic auctions have generalized the traditional exact dynamic auctions for the scenario in which agents can demand bundles of items. In certain aspects, such generalized auctions converge to the smallest Walrasian prices, and display strategy-proofness when the smallest Walrasian prices correspond to the Vickrey-Clarke-Groves (VCG) payments. Yet, such generalized dynamic auctions support a limited form of bid revision. For instance, an agent is free to revise its bid on a bundle as long as the demands on the bundle specified in all preceding rounds remain consistent with the revision.

It should be appreciated that certain dynamic auctions (e.g., general, conventional combinatorial auctions) can support more complex preferences than unit-demand preferences, such as preferences for bundles of items. Yet, for many of such combinatorial auctions, the problem of finding an efficient allocation is non-deterministic polynomial-hard (NP-hard). Accordingly, computational intractability of general combinatorial auctions commonly leads to development of specialized combinatorial auctions that afford finding an allocation efficiently in polynomial time.

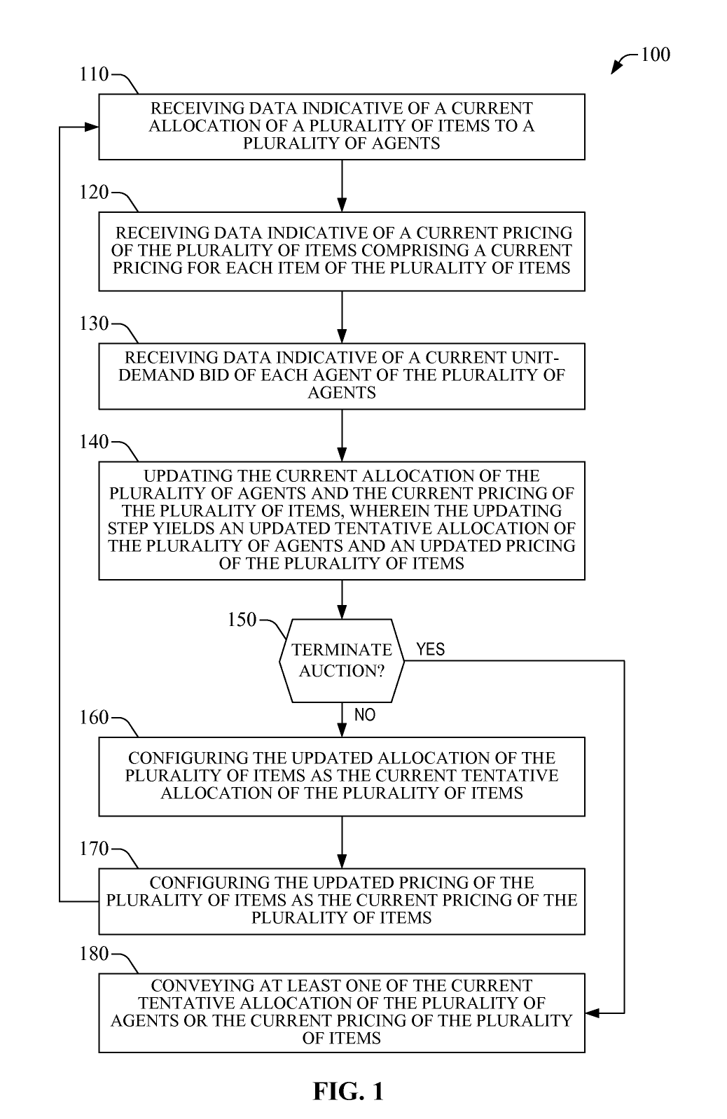

In embodiments of the subject disclosure, in a dynamic unit-demand auction, bidding takes place in multiple rounds, as shown in FIGS. 1-4.

There is a rich design space of possible dynamic unit-demand auctions. There are a number of formal criteria that may be used to gauge the quality of such an auction. No single auction can achieve optimality with respect to all of these criteria simultaneously.

Embodiments of the subject disclosure specify the input-output behavior of a novel dynamic unit-demand auction. Through rigorous mathematical analysis, it can be shown that the proposed auction is optimal or nearly-optimal with respect to a comprehensive collection of important criteria. The auction is suitable for integration into the bidding interfaces associated with certain existing online auction houses.

### 2. Preliminary Information

In certain embodiments of auctions that are described herein, item prices are allowed to be arbitrary integers. In other embodiments of such auctions, item prices are non-negative (or prices are represented by a natural numbers). In yet other embodiments, a price of an item can be represented by a real number. As described herein, negative prices can be permitted because such prices do not introduce significant additional complexity and allow support for pricing of procurement-type items. For example, a person who is willing to pay up to $10 for a haircut can list the haircut as an item with a starting price of −$10 (negative ten dollars). Various barbers can submit bids to compete for the person's business. For example, a barber who is willing to provide the haircut for as little as $8 can submit an offer of −$8 (negative eight dollars). There are also scenarios (e.g., disposal of recyclable waste) where an item might be assigned a negative starting price, and end up selling for a positive price. Thus it is useful for an auction to provide seamless support for both positive and negative prices (either integer or real).

A unit-demand bid can assign a specific value to each item in an auction. In typical auction scenarios, an agent can be interested in a small subset of the set of items being auctioned. In the subject disclosure, if an agent u is not interested in acquiring a particular item v, then the offer of agent u for item v is −∞ (negative infinity). Accordingly, each offer (or component) of a unit-demand bid is either an integer or −∞.

The term “delta bid” is used herein to refer to a unit-demand bid where all but one of the offered amounts is equal to −∞. The phrase “delta bid on item v” is used herein to refer to a delta bid that offers −∞ for every item except item v.

A solution to a unit-demand auction instance comprises an allocation of an agent to an item of a set of items, and pricing of at least one item of the set of items. In one aspect, an allocation can assign all items of the set of items to agents in such a way that no agent receives more than one item. Dummy agents (e.g., representing seller(s) of item(s)) can be introduced in the various auctions described herein where necessary in order to ensure that such an allocation is always possible. A pricing can assign an integer price to each item of the set of items; yet, the pricing also can assign prices that are real numbers.

In the context of a unit-demand auction, there are two aspects of the “value” assigned by an agent u to an item v: The private value that u assigns to v, and the component of agent u's unit-demand bid associated with item v. This leads to two aspects of the “profit” that can be obtained by an agent through participation in an auction. One aspect of profit is “utility,” which understood conventionally. Another aspect of profit is “gap”. In general, if an agent bids truthfully, utility and gap coincide. “Gap” is specific to the subject innovation and employed in order to ensure that the two aforementioned aspects of profit can be clearly distinguished.

Given a solution to a unit-demand auction instance, the utility of an agent u is defined as follows: if no item is allocated to u, then the utility of agent u is zero; if item v is allocated to agent u, then the utility of the agent u is the difference between the value that the agent u assigns to item v and the price of v. If item v is allocated to agent u, and agent u is not interested in acquiring item v, then the utility of agent u is −∞.

Given a solution to a unit-demand auction instance, the gap of an agent u is defined as follows: if no item is allocated to the agent u, then the gap of the agent u is zero; if item v is allocated to agent u, then the gap of the agent u is the difference between the offer of the agent u for item v and the price of item v. If item v is allocated to agent u, and the offer of the agent u for item v is −∞, then the gap of agent u is −∞.

Provided a pricing of the items, an item v is said to be a demand of agent u if the gap of the agent u is maximized by any allocation that assigns the item v to the agent u.

### 3. Sealed-Bid Unit-Demand Auctions

Dynamic unit-demand auctions of the subject disclosure can rely, at least in part, in terms of a sequence of at least three sealed-bid (SB) unit-demand auctions. Such SB unit demand auctions are referred to herein as Auction SB1, Auction SB2, and Auction SB3. Before describing in detail these three sealed-bid auctions, their relationship to one another is discussed, as is their relationship to embodiments of the described dynamic unit-demand auction.

Auction SB1 is a variant of a standard sealed-bid unit-demand auction. Auction SB2 introduces certain tie-breaking conventions to specialize Auction SB1 in a manner that proves to be useful for embodiments of the subject disclosure. Auction SB3 is a novel auction that can be defined in terms of Auction SB2. The design of Auction SB3 is geared towards supporting bid revision in its most general form. The various embodiments of a dynamic unit-demand auction described herein (see, e.g., Secs. 4-5) are based on repeated application of Auction SB3: In each round, a single application of Auction SB3 is used to update the tentative allocation and pricing.

### 3.1. Auction SB1

A set of items is to be sold in the auction. Each item in the set of items has a public starting price (e.g., an integer price) and a private reserve price (e.g., an integer price) that is greater than or equal to the public starting price. There is a set of agents, each of the agents supplying a sealed unit-demand bid over the set of items. Without intent to be limiting, it can be assumed that for each item v there is a corresponding “dummy” agent representing a seller of v, wherein a unit-demand bid of the seller is a delta bid on item v, such that the amount offered for item v is equal to the reserve price of v. In certain scenarios in which the seller of item v does not wish to specify a reserve price, the reserve price can be treated as being equal to the starting price.

Provided the above input, implementation of Auction SB1 comprises determination (e.g., computation) of an allocation and pricing of at least one item (e.g., each item) in the set of items as follows. In one aspect, the allocation can be determined by computing a maximum-weight maximum-cardinality matching (MWMCM) of a complete edge-weighted bipartite graph having nodes on a first side of such graph that correspond to the agents in the set of agents and nodes on a second side of such graph that correspond to the items in the set of items, and wherein a weight of an edge in such graph from an agent u to an item v is equal to an offer of u for v, as specified in the unit-demand bid of agent u. In another aspect, if there is more than one MWMCM, implementation of the Auction SB1 can comprise generation of the allocation based on an arbitrarily chosen MWMCM. Because the allocation corresponds to an MWMCM, Auction SB1 is efficient.

In certain embodiments, Auction SB1 can determine the pricing of the items in the set of items as describer hereinafter. The approach is to set the prices so that Auction SB1 satisfies the following two properties:
(1) Envy-freedom. This property is satisfied if the gap of any agent is nonnegative, and for any allocated agent u and item v, the gap of u is at least as large as the difference between the offer of agent u for v and the price of item v. Informally, envy-freedom ensures that for the given pricing, all agents are satisfied with the allocation.
(2) Truthfulness. A sealed-bid unit-demand auction is said to be truthful if it is a weakly dominant strategy for a utility-maximizing agent with unit-demand preferences to bid honestly. Informally, truthfulness implies that an agent with unit-demand preferences does not need to waste time strategizing about how other agents might bid; instead, such an agent should simply bid his or her true preferences.

It can be demonstrated that there is a unique manner to price the items so that properties (1) and (2) are satisfied regardless of which MWMCM is utilized to determine the allocation. In one aspect, Auction SB1 produces prices in such a manner. Such prices are typically referred to as VCG prices because they correspond to unique prices determined by the Vickrey-Clarke-Groves (VCG) mechanism when applied to dynamic unit-demand auctions in accordance with the present disclosure. As an illustration, the VCG mechanism is described in, for example, (a) W. Vickrey, Counterspeculation, auctions, and competitive sealed tenders, Journal of Finance, 16:8-37, 1961; (b) E. H. Clarke, Multipart pricing of public goods, Public Choice, 11:17-33, 1971; and (c) T. Groves, Incentives in teams, Econometrica, 41:617-631, 1973.

A fast implementation of Auction SB1 can be accomplished through various conventional methods. For example, the well-known Hungarian method (as described in H. Kuhn. The Hungarian method for the assignment problem, Naval Research Logistics Quarterly, 3:253-258, 1955) can permit the fast implementation of Auction SB1. For another example, the closely related successive shortest paths method (as described in R. K. Ahuja, T. L. Magnanti, and J. B. Orlin. Network Flows. Prentice Hall, New York, N.Y., 1993) can permit the fast implementation of Auction SB1. These methods maintain a dual variable for each item. Such dual variables can directly provide the desired item prices.

### 3.2. Auction SB2

The Auction SB1 described herein incorporates a degree of non-determinism since the allocation is provided by an arbitrary MWMCM and there may be many MWMCMs. In certain embodiments, Auction SB2 specializes Auction SB1 by restricting a choice of MWMCM that can be utilized to determine the allocation. Restriction of the choice of MWMCM generally does not uniquely determine such, but it can uniquely determine a set of allocated agents. One motivation for specializing Auction SB1 in this manner is to ensure that Auction SB3, which is defined below in terms of Auction SB2, satisfies certain important mathematical properties.

In one aspect, Auction SB2 can restrict the choice of MWMCM as follows. Without intent to be limiting, it can be assumed that, as part of input to Auction SB2, a ranking of agents in the set of agents is given. Any MWMCM is associated with a tuple of allocated agents, wherein the tuple is listed in descending order with respect to the ranking of the agents. It should be appreciated that such tuple can be ordered lexicographically. Auction SB2 can restrict the choice of the MWMCM utilized to determine the allocation by requiring the tuple associated with the MWMCM to be lexicographically maximum over all MWMCMs.

While the foregoing discussion specifies the desired input-output behavior of Auction SB2, it does not directly provide an efficient algorithm for implementing the auction. Yet, in one aspect, the fast methods cited earlier for implementing Auction SB1 are easily modified to ensure that the allocation satisfies the lexicographically maximum condition. Furthermore, the modified versions of such methods have the same time complexity as the original versions.

### 3.3. Auction SB3

The sealed-bid unit-demand auction discussed in this section, Auction SB3, comprises a building block for an embodiment of a dynamic unit-demand auction mechanism in accordance with aspects of the subject disclosure.

The input to Auction SB3 comprises a set of items, a set of agents, and a tentative allocation. In one aspect, each item of the set of items has a public tentative price (e.g., an integer public price). In another aspect, each agent in the set of agents can supply a sealed unit-demand bid over the set of items. The fact that item v is tentatively allocated to agent u does not imply that v is a demand of u, since the unit-demand bid of the agent u is allowed to be arbitrary. In yet another aspect, the unit-demand bid of agent u is not restricted because it is desired to use Auction SB3 to support arbitrary bid revision in the context of the dynamic unit-demand auction described herein.

Auction SB3 can comprise two phases, which are described in detail in Sections 3.3.1 and 3.3.2, respectively.

### 3.3.1. First Phase

The behavior of a first phase of Auction SB3 can be specified as an output of an iterative procedure (also referred to as an iterative cycle). Such iterative procedure can be viewed as a natural bargaining process. The iterative procedure can maintain a dynamic partition of the set of agents into three sets: encumbered, unencumbered, and dominated. Initially, tentatively allocated agents in the set of agents are classified as encumbered agents, and the remaining agents in the set are classified as unencumbered agents. In each iteration of the iterative procedure, the tentative allocation and pricing can be updated, and an agent can transition from being classified as encumbered (e.g., encumbered agent) to being classified as unencumbered (e.g., unencumbered agent), or from being classified as unencumbered to being classified as dominated. No other agent classification transitions are possible. If an agent u is classified as encumbered at the start of a specific iteration, it is guaranteed that the agent u has been tentatively allocated to the same item v since the outset of the iterative procedure, and that the tentative price of v has not changed since the outset of the iterative procedure. Classification of an agent (e.g., agent u) as “encumbered” is based on the fact that it is yet to be established whether the agent can be released from an obligation to support the current price of v. For at least this reason, in a more detailed description of an iteration that is described herein, the unit-demand bid of an agent (e.g. agent u) is not examined while the agent remains classified as encumbered. In one aspect, in the iterative procedure described herein, dominant agents are not allocated.

In one aspect, at the start of an iteration, a determination is made whether there are any unencumbered agents that are not allocated. If outcome of the determination indicates that there are no unencumbered agents that are not allocated, the first phase terminates. In the alternative, if there are unencumbered agents, then an unencumbered agent u₀ is selected and the allocation and pricing is updated by computing a solution to an instance of Auction SB2 defined, or constructed, as described in detail hereinafter.

In one aspect, all items are included in the instance, but only a subset A of the agents comprising the allocated agents and the unencumbered agent u₀. The unit-demand bids of the unencumbered agents in the subset A are included unchanged in the Auction SB2 instance. In another aspect, the unit-demand bid of each encumbered agent u in A is replaced; for example, if the item allocated to encumbered agent u is item v, then the unit-demand bid of the encumbered agent u is taken to be a delta bid on item v, wherein the offer for item v is equal to a current price of item v. In yet another aspect, to complete the construction of the instance of Auction SB2, a ranking of the agents in A can be specified. To at least such end, each agent in the subset A can be considered to have a unique identifier drawn from a totally ordered set, and the desired ranking of the agents in A can be determined based at least on respective agent identifiers. For example, in certain embodiments, all unencumbered agents in A can be ranked higher than the encumbered agents in A. In addition, within a set of encumbered agents and a set of unencumbered agents, the ranking of the agents can be determined by the order of the agent identifiers within the respective sets.

After an instance of Auction SB2 has been constructed in accordance with the aspects described herein, a solution to such instance can be determined, and a new tentative allocation and pricing can be obtained from such solution. It should be appreciated that the instance of Auction SB2 can be akin to a game of musical chairs: There is exactly one more “player” (e.g., agent) than there are “chairs” (e.g., items), and exactly one agent fails to be allocated in the resulting solution. In the subject disclosure, if an agent that is not allocated in a current iteration is unencumbered, then the agent becomes dominated in the next iteration, which effectively eliminates the agent from consideration in all subsequent iterations of the first phase of the Auction SB3. In the alternative, if the agent that is not allocated is encumbered, then the agent becomes unencumbered in the next iteration.

In the subject disclosure, termination of the first phase of Auction SB3 is guaranteed because each iteration of the first phase either transitions an agent from unencumbered to dominated or from encumbered to unencumbered.

Disparate implementations of the first phase of Auction SB3 as described herein can have disparate time complexity. In one aspect, a direct implementation of such first phase can have polynomial time complexity. In another aspect, several optimizations of implementation of the first phase of Auction SB3 can yield efficient implementations. In certain embodiments, the latter can be accomplished as described in greater detail below (see, e.g., Sec. 4.1).

### 3.3.2. Second Phase

After the first phase terminates, a second phase of Auction SB3 can begin. Implementation of the second phase enables remaining encumbered agents to trade items with one another. Whereas the first phase affects both allocation and pricing, the second phase affects only the allocation of the encumbered agents and their associated items; allocation of the remaining agents and the prices of items allocated to such agents are left unchanged.

In certain embodiments, a desired allocation of encumbered agents can be obtained via a reduction to a suitably defined instance of a house allocation problem, as described, for example, in L. Shapley and H. Scarf, On cores and indivisibility, Journal of Mathematical Economics, 1(1):23-37, 1974. In the house allocation problem, each of n homeowners owns a house. Each homeowner independently ranks the n houses from most preferred to least preferred. The conventional Top Trading Cycles method can be used to determine a unique allocation of the n houses to the n homeowners satisfying certain mathematical properties typically deemed desirable. In one aspect, in the second phase of Auction SB3, an instance of the house allocation problem with a homeowner for each encumbered agent is constructed, wherein an initial house of an encumbered agent u corresponds to a unique item v that is allocated to the encumbered agent u. In another aspect, each encumbered agent u can rank the “houses” based on the difference between the offer of the encumbered agent u and a current price of item v. A tie in such ranking can be removed based on a fixed ordering of the items, e.g., using item identifiers.

### 4. Exemplary Embodiments of a Dynamic Unit-Demand Auction

Described herein is an embodiment of a dynamic auction in which a single implementation of Auction SB3 is used to update the tentative allocation and pricing in each round. The output of the last round determines the final allocation and pricing. Below a more precise description of the input to each implementation of Auction SB3 is given.

At the beginning of a first round, tentative pricing is provided by starting prices of a set of items to be auctioned, as described in connection with Auction SB1 and Auction SB2. At the beginning of the first round, each item v of the set of items is tentatively allocated to a dummy agent for item v, as described in connection with Auction SB1 and Auction SB2. The unit-demand bid of the dummy agent for item v can be defined in terms of a reserve price of item v as described in Auction SB1 and Auction SB2. Other non-dummy agents can be present in the first round, each of such agents can have an associated unit-demand bid, which can be arbitrary.

At the beginning of a non-first round, the tentative allocation and pricing is provided by the solution to the application of Auction SB3 associated with a previous round. In one aspect, the set of agents appearing in the non-first round can be equal to the union of at least the two sets: A first set σ₁ comprising agents that were tentatively allocated at the end of the previous round; and a second set σ₂ comprising non-dummy agents that were not tentatively allocated at the end of the previous round, and that are submitting a new unit-demand bid in the current round. In exemplary implementation, for each agent u in the first set, the associated unit-demand bid in the current round is determined as follows: if an agent u submits a revised bid in the current round, then the revised bid is taken to be the bid of agent u; otherwise, the bid of the agent u is taken to be the same as in the previous round. In such exemplary implementation, a dummy agent is not allowed to revise its bid, since the bid of a dummy agent is intended to model a fixed reserve price of a seller of item v.

In certain embodiments, Auction SB3 can be implemented with a fixed total order over the set of agents and a fixed total order over the set of items. Yet, various mathematical properties of the Auction SB3 can be maintained even if total orders of agents or total order items change among disparate implementations of the Auction SB3. In one exemplary implementation of Auction SB3, a single total order over the items can be utilized; for example, such total order can be derived by sorting a fixed set of item identifiers. In another exemplary implementation of Auction SB3, a more complex scheme can be utilized for determining the total order over the agents. In one aspect of such scheme, all dummy agents can be ordered lower than all non-dummy agents in each round of the Auction SB3; such ordering can ensure that an item can be sold to a non-dummy agent at the starting price. In another aspect of such scheme, within the set of dummy agents, a predetermined (e.g., arbitrarily predetermined) fixed total order can be utilized in all rounds, whereas within the set of non-dummy agents, a dynamic timestamp-based ordering can be used, wherein a timestamp of an agent can be determined as follows. In the first round of an Auction SB3, all agents can be assigned a common timestamp. In a non-first round i, and in view that agents can be partitioned into sets σ₁ and σ₂ described herein, a timestamp i can be assigned to all of the agents in set σ₂. Each agent u in set σ₁ can be assigned the minimum timestamp j less than i such that agent u is tentatively allocated in rounds j through i−1. Having determined such timestamps, a pair of agents u₀ and u₁ participating in round i of Auction SB3 can be ordered as follows: if agent u₀ and agent u₁ have distinct timestamps, then the agent in such pair having the greater timestamp is considered to have a lower order; if agent u₀ and agent u₁ have equal timestamps, then the order of the agents is determined by a predetermined (e.g., arbitrarily predetermined) fixed total order. At least one advantage or benefit of the proposed dynamic timestamp-based scheme is that it can remove ties in favor of agents that have been allocated for a longer period.

### 4.1 Time Complexity

Implementing a round of a dynamic unit-demand auction of the subject disclosure can comprise solving an instance of Auction SB3, which includes two phases. In certain embodiments in which the second phase of Auction SB3 is solved through execution of a Top Trading Cycles algorithm, the second phase of Auction SB3 can be implemented with low time complexity. Accordingly, an exemplary approach to reduce time complexity of the Auction SB3 can focus on reducing time complexity of the first phase of the Auction SB3.

In a scenario in which an instance of the first phase of Auction SB3 has n items and m+n agents, wherein n of such agents are tentatively allocated, direct implementation of the first phase of Auction SB3 as described herein (see, e.g., Sec. 3.3.1) can comprise solving a sequence of a number of O(m+n) of instances of Auction SB2. In one aspect (see, e.g., Sec. 3.2), an instance of Auction SB2 can be solved by implementing (e.g., executing) a Hungarian method or a successive shortest paths method. Such methods are iterative and an iteration thereof can often be referred to as an augmentation. In another aspect, solving an instance of the Auction SB2 can comprise introducing each agent of a set of agents one at a time, employing a single augmentation to incorporate each successive agent into a solution of the Auction SB2. The time complexity of performing an augmentation can be similar for both the Hungarian method and the successive shortest paths method. For the latter, the time complexity can be upper bounded by a cost of solving a conventional single-source shortest paths problem on a graph with a node for each item of a set of items and an edge for each active bid component. A bid component can be considered active if an associated offer is at least as high as the tentative price of the item associated with the bid component. In certain auction scenarios, an average number of active bid components of a tentatively allocated agent can be small, e.g., at most a constant of the order O(1). In such scenarios, the number of active bid components can be linear in the number of items of a set of auctioned items; hence, in an aspect, an amortized cost of each augmentation can be close to linear in the number of items. In what follows, we seek to optimize the overall time complexity of our auction in terms of the total number of augmentations performed.

As described herein, an instance of Auction SB2 can be solved by utilizing a single augmentation to incorporate an additional agent. Similarly stated, a target instance I of Auction SB3 can be solved by solving a sequence of instances of Auction SB2 culminating in instance I, such sequence obeying the following conditions: (a) each successive instance in the sequence is the same as the previous instance except that it involves one additional agent; and (b) each successive instance in the sequence can be solved by applying a single augmentation to a solution of the previous instance. A similar technique can be employed to solve a sequence of instances of Auction SB2 that can occur within an instance of Auction SB3; thus, each such instance of Auction SB2 can cost at most one augmentation.

It should be appreciated that O(m+n) augmentations can suffice to solve an arbitrary instance of Auction SB3 with n items and m+n agents. While this complexity bound is sufficiently low for many implementations, in certain embodiments the scalability of dynamic unit-demand auctions described herein can be improved. For example, in one embodiment, a total number of augmentations performed across all rounds of a dynamic unit-demand auction can be linear in the total number of bidding operations, wherein a bidding operation can be a bid revision submitted by a tentatively allocated agent or a new bid submitted by an agent that is not tentatively allocated.

An agent u in the auction is envy-free if the gap of the agent u is nonnegative and for any item v, the gap of the agent u is at least as large as the difference between the offer of agent u for item v and the price of v. Such gap is defined, for example, in Sec. 2.

An Auction SB3 described herein (see, e.g., Sec. 3.3.1) can be modified to improve time complexity and thus increase the various efficiencies (e.g., formal properties and related benefits). In one or more embodiments, a first modification can comprise classifying a first group of tentatively allocated agents (e.g., each tentatively allocated agent in a set of agents) that are not envy-free as encumbered, and classifying a second group of agents (e.g., remaining agents in the set of agents) as unencumbered, rather than initially classifying each tentatively allocated agent of a plurality of agents as encumbered and each remaining agent of the plurality of agents as unencumbered. In one aspect, a formal property of a dynamic unit-demand auction (with or without the first modification) is that if an agent u is tentatively allocated and not envy-free at the end of a current round, either (i) agent u performed a bid revision operation in the round or (ii) the agent u was tentatively allocated and not envy-free at the end of a previous round. Such formal property can permit to prove that, under the first modification, a total number of augmentations performed in response to implementing a dynamic unit-demand auction of the subject disclosure is linear in the total number of bidding operations (bid submission, bid revision, etc.). Therefore, the average cost of a bidding operation can be proportional to the cost of a single augmentation.

In other embodiments, a second modification of the first phase of an Auction SB3 can be provided. The second modification can generalize the first modification. As described herein, implementing Auction SB3 can comprise applying a sequence of augmentations, one for each instance of Auction SB2 associated with the Auction SB3. Under such modification, an initial partition of agents into a set of encumbered agents (e.g., a first set of agents) and a set of unencumbered agents (e.g., a second set of agents) can be the same or substantially the same as one such partition effected under the first modification. Yet, under the second modification, if an augmentation causes an encumbered agent u to become envy-free, e.g., with respect to the tentative pricing and allocation in effect immediately after the augmentation, then the agent u can transition from the set of encumbered agents to the set of unencumbered agents before proceeding to a next augmentation. In one aspect, a formal property of a first phase of Auction SB3 (with or without the first or second modification) is that if an agent u is not envy-free in a solution obtained after applying an augmentation, then the agent u is not envy-free in a solution preceding the augmentation. It should be appreciated that providing at least one of the first modification or the second modification allows reduction of a total number of augmentations performed in response to implementation of a dynamic unit-demand auction of the subject disclosure. It should be appreciated further that the second modification can achieve, in general, a greater reduction of time complexity than the first modification. Yet, a worst-case asymptotic time complexity can remain the same—e.g., the total number of augmentations is linear in the total number of bidding operations.

In certain scenarios, while the first modification and the second modification described herein can improve time complexity of a dynamic unit-demand auction of the subject disclosure, such modifications may not precisely preserve the input-output behavior of the dynamic unit-demand auction. Stated in alternative terms, tentative pricing and allocation determined (e.g., computed) in a round of the dynamic unit-demand auction can be different if the round is implemented in non-modified form, or with the first modification, or with the second modification. Without intending to be limited by theory or modeling, it is believed that such difference can arise from the specific manner in which the first modification or the second modification influence how certain ties are resolved within Auction SB3. Yet, dynamic unit-demand auctions in accordance with aspects of the subject disclosure are designed, and thus can be implemented, to preserve strong formal properties regardless of the details of implementation of tie resolution. For example, Auction SB3 can be defined in terms of Auction SB2, and in Auction SB2 a fixed ranking of the agents can be employed to break certain ties. Accordingly, in one aspect, the output of the Auction SB2, and hence that of Auction SB3, can depend at least on a specific selection of such ranking. But regardless of the specific selection of the ranking, a solution is guaranteed to satisfy the particular solution concept targeted by the Auction SB3. Thus, a solution generated by the unmodified version of Auction SB3 is not preferred over a solution generated under a modified version of the Auction SB3, or vice versa. In one aspect, the second modification described herein can yield the greatest improvement in time complexity, thus in certain embodiments it can be advantageous to incorporate the second modification into an implementation of a dynamic unit-demand auction of the subject disclosure.

### 5. Alternative Embodiments

Described herein are certain exemplary variations of the auction framework established in Section 4.

In one aspect of an embodiment described herein, a dynamic unit-demand auction, the number or granularity of the rounds in the auction was not specified. In one aspect, there can be a fixed number of rounds, where each round is of fixed duration. In an exemplary scenario in which the duration of a round is vanishingly small, a continuous version of the auction is obtained in which each non-trivial round processes exactly one operation, either a new bid or bid revision. It can be readily verified that if an embodiment of the described auction does not receive new bid data in a particular round, then the round is determined to be a no-op, e.g., the tentative allocation and pricing does not change in that round. In another aspect, the number of rounds can be determined dynamically. For example, the auction can be automatically extended as long as at least one price change occurs. The granularity of the rounds also can be determined dynamically.

In another aspect, it is contemplated that the set of items for sale in the auction is static. However, in one aspect, an auction of the subject disclosure can be modified to allow new items to be introduced in one or more rounds (e.g., in each round).

In yet another aspect, existence of a single “last round” in which all of the items are sold has been assumed. However, such assumption can be relaxed. For example, a separate expiration time for each item in the auction can be specified, and unit-demand bidding across items that expire within the same interval of time (e.g., a specific 24-hour period) can be permitted. It should be appreciated that unit-demand bids introduced after the expiration time of the item v cannot make an offer on such item v. However, an agent u that is not tentatively allocated to item v at the expiration time of the item v might have made an offer on such item v as part of a unit-demand bid submitted prior to the expiration of item v, and therefore v might become allocated to agent u before the end of the interval of time. In implementations with an expiration time for an item v, a seller of the item v may not necessarily be informed of the price and buyer of the item v at the expiration time of v; instead, it may be necessary to wait until the end of the interval. In additional or alternative embodiments, a seller of each item v can specify, along with an expiration time for each item, an upper bound on a delay after the expiration time elapses that the seller can tolerate before acquiring information related to a final price and buyer. Such embodiments that include item-specific delay bounds may establish constraints on the set of permissible unit-demand bids. Yet, it can be feasible to manage such constraints through the use of standard algorithmic techniques.

While the tentative allocation and pricing is generally made public at the end of each round, in one aspect, identities of tentatively allocated agents can be made anonymous in response to publication of such information.

It should be appreciated that the various embodiments of the subject disclosure disregard costs of shipping an item from the seller to the buyer, which typically depends on the nature of the item and geographic locations of the seller and buyer. Shipping costs can be an important consideration for many items sold in web-based, online auctions. In certain scenarios, a buyer may be requested to pay the shipping costs in addition to the auction price. Each item listing can specify a cost of shipping to a potential buyer, for example, via a shipping calculator. Addition of shipping costs to an auction prize can permit incorporation of shipping costs into a dynamic unit-demand auction in accordance with aspects described herein.

In certain embodiments, a seller can offer an item with optional add-ons. For example, a car might be offered for sale with the option to pay an extra cost (e.g., $200) for new tires. In one aspect, add-on costs can be handled in substantially the same manner as shipping costs—for instance, implementation of a unit-demand auction can determine a price of the “base configuration” of an item without add-ons and a buyer of the item can pay such price plus cost of any desired add-ons.

In other embodiments, it may be desirable for a seller to offer different variants of an item as separate auction items, subject to the restriction that at most one of these items may be sold. This feature can be readily implemented within a dynamic unit-demand auction as disclosed herein.

As described herein, the second phase of Auction SB3 can be resolved through reduction to a suitably defined instance of a house allocation problem. In one aspect (see, e.g., Sec. 3.3.2), when solving such an instance of the house allocation problem via the Top Trading Cycles algorithm, a fixed ordering of a subset of items can be utilized to remove ties. In an example, the Top Cycle algorithm (for example, described in P. Jaramillo and V. Manjunath, The difference indifference makes in strategy-proof allocation of objects, in Social Science Research Network, http://ssrn.com/abstract=1809955) generally is designed to solve instances of the house allocation problem in the presence of ties. Thus, such algorithm can be executed to solve an instance of the Auction SB3. In certain embodiments of the dynamic unit-demand auction described herein, each execution of the Top Trading Cycles algorithm can be replaced with a corresponding execution of the conventional Top Cycles algorithm. In such embodiments, the tentative allocation of a set of agents that is determined (e.g., computed) in each round is Pareto-efficient—that is, agents cannot trade their tentatively allocated items amongst themselves in a fashion that results in an agent being better off (e.g., experiencing an increase in associated utility) while no agent is worse off (e.g., experiencing a decrease in associated utility). Pareto-efficiency property represents a strengthening of the weak core property achieved in various embodiments of the dynamic unit-demand auction described herein (see, e.g., Sec. 4). In connection with time complexity, while the Top Cycles algorithm has polynomial time complexity, such time complexity is substantially higher than that of the Top Trading Cycles algorithms. Accordingly, replacing the Top Trading Cycles algorithm with the Top Cycles algorithm in embodiments of a dynamic unit-demand auction described herein can yield a substantial increase in worst-case time complexity.

### 5.1 Static Price Adjustments

Several costs can be associated with an auctioned item in addition to a pricing resulting from implementation of an auction. As discussed herein such costs can be agent and item specific (e.g., shipping costs) and, in general, can be positive or negative. Examples of such costs include costs associated with shipping, optional add-ons, and different variants of an item within a unit-demand auction. More generally, an item that is auctioned can have one or more adjustment costs associated therewith and established by a seller of the item.

As an example, in a single-item auction, a seller can publish a static function adj(u) as part of the auction listing, and if agent u wins the single-item auction, then the agent u can pay the auction price plus a fee determined by the outcome of adj(u). In one embodiment, the auction listing of the seller can provide the necessary information (shipping calculator, fixed price adjustments for different variants, etc.) to enable an agent u to determine a pertinent price adjustment to be paid in the event that agent u wins the single-item auction. In one aspect, the price adjustment is a function of the agent, as opposed to the agent and other factor associated with the item (e.g., item variants) because the agent can select the relevant item variant based on related published cost adjustments. Accordingly, the task of supporting multiple variants of an item within a single-item auction can be reduced to the single-variant case.

In certain embodiments, for a unit-demand auction, a static price adjustment function adj(u,v) that specifies a fee to be added to the auction price can be defined in order to determine the total price paid by agent u for item v. Apart from the price adjustment performed at the end of the auction, calculation performed in response to implementation of a unit-demand auction as described herein depends on the non-adjusted bids. Accordingly, it is readily apparent that a formal property established for a dynamic unit-demand auction described herein can be maintained with respect to the non-adjusted bids or non-adjusted prices. For example, regarding truthfulness of an individual round of the dynamic unit-demand described herein, a non-adjusted bid of agent u is truthful if the corresponding adjusted bid is equal to the truthful preferences of the agent u.

### 5.2 Dynamic Price Adjustments

Several implementations of price adjustment are contemplated. For example, one implementation includes a specific price adjustment function adjᵢ for each round i of the dynamic unit-demand auction. In one aspect, the function adjᵢ can be determined by a public component of bidding history up to the start of round i, and that for an agent u, item v, and rounds i and j such that i<j, the relationship adjᵢ(u,v)≦adjⱼ(u,v).

When an agent u wins an item v, agent u pays the auction price plus adjᵢ(u,v), where i is the index of the earliest round such that for all rounds with index j where i≦j, agent u is tentatively allocated in round j, and the difference between the offer of agent u related to item v in round j and the price of item v in round j is either non-negative or at least as high as the gap of agent u in round j. In one aspect, the latter condition can indicate whether a unit-demand bid of agent u still has a likelihood of winning item v in a subsequent round of the unit-demand auction, even if it remains unchanged.

As an example, consider a 10-round auction where the rounds are numbered from 1 to 10, and where adj(u, v, i) is defined as the sum of (1) a static value adj(u,v) that models shipping costs and other agent and item specific adjustments as described in Sec. 5.1, and (2) (i−1)% of the tentative price of item v as of the start of round i. Since the tentative price of item v at the start of round i is a public component of the bidding history up to the start of round i, and since the tentative price of an item cannot decrease from one round to the next, any such choice of the function adjᵢ satisfies the technical conditions set forth in the preceding paragraph.

The dynamic price adjustment scheme described herein enjoys all of the mathematical properties disclosed herein. In an aspect, constraining function adjᵢ to be determined by a public component of a bidding history up to the start of round i can ensure that shill-resistance of a dynamic unit-demand auction is preserved. In another aspect, relaxation of such constraint, on the choice of the function adjᵢ can reveal private information related to the bids of tentatively allocated agents. Scalability of a dynamic unit-demand auction described herein is unaffected by dynamic price adjustment since price adjustments to be applied at the end of such auction can be readily computed—in one aspect, tentative price adjustments can be computed at the end of each round without increasing the asymptotic complexity of processing a round of the dynamic unit-demand auction.

In one aspect, constraining adjᵢ(u,v) to be non-decreasing in round index i can encourage early bidding behavior in a dynamic unit-demand auction as described herein. For instance, in a scenario in which agent u wins item v and a rule for price adjustment rule prescribes that agent u pays the auction price plus adjᵢ(u,v), a non-negative value obtained by subtracting adj₁(u,v) from adjᵢ(u,v) embodies a “sniping fee” incurred by agent u in response to not bidding earlier in the dynamic unit-demand auction. Conventionally, the term “sniping” refers to submitting a bid in the last few seconds of an auction. Yet, as utilized in the subject disclosure, the term “sniping” is more comprehensive, since our sniping fee structure can be multi-tiered to discriminate between bids submitted with arbitrarily varying amounts of time remaining in the auction.

In an exemplary implementation of the dynamic price adjustment of the subject disclosure, a unit-demand auction is considered in which the listing of each item v specifies, at the outset of such auction, the value of adjᵢ(u,v) for all agents u and rounds i. For i=1, such values can be used to model shipping costs and item variants as discussed herein (see, e.g., Sec. 5.1). A sniping fee applicable to bids submitted in such first round is zero. For any agent u and round i>1, the quantity Δᵢ(u,v)=adjᵢ(u,v)−adjᵢ₋₁(u,v) is indicative of a non-negative change in sniping fee when transitioning from round i−1 to round i. It should be appreciated that Δᵢ(u,v) (or a sniping fee) for item v can be accrued even while the item v remains tentatively allocated to a dummy agent for the item v; such accrual can result from not reaching a reserve price for the item v. To mitigate such accrual, in certain embodiments, a seller of the item v can specify how sniping fees can accrue after a reserve price for item v has been fulfilled. In one aspect, specification of sniping fee accrual by a seller can introduce complexity to the sniping fee structure (or schedule) of a unit-demand auction due at least in part to a nontrivial dependence on the bidding history. Yet, dynamic price adjustment in unit-demand auctions described herein contemplates such complex scenarios.

In certain embodiments, a sniping fee schedule for an item can be implemented for a continuous auction (e.g., a web-based online auction) with a fixed duration (e.g., one-week duration). It should be appreciated that similar, yet not identical, consideration can arise in the design of sniping fee schedules for other auction formats. In a continuous auction, a tentative pricing and allocation generally is updated substantially immediately after a bidding operation is received, which can correspond to such auction having rounds of a fixed, infinitesimally small interval of time. An exemplary sniping fee schedule for a one-week continuous auction can comprise a sniping fee that increases linearly from zero—at the time when the reserve price is fulfilled—to a seller-specified maximum value at the end of the continuous auction. It should be appreciated that such a sniping does not increase significantly during the final stages (e.g., the last hour) of the continuous auction. From the perspective of allowing competing agents to engage in additional value discovery in response to an agent's bid, there is a significant difference between bidding with a first period (e.g., ten seconds) prior to termination of the continuous auction and bidding within a second period prior such termination, e.g., with one minute left in the auction, with five minutes left in the auction, or with an hour left in the auction. Another exemplary snipping fee schedule can comprise a snipping fee that is proportional to the logarithm of the ratio of the auction duration (e.g., one week) to the time remaining in the auction (e.g., one hour). Doing so can result in an additive increase in the sniping fee whenever the time remaining decreases geometrically. In certain embodiments, this can be considered appropriate since a geometric decrease in the time remaining has a qualitative impact on the ability of agents to engage in value discovery.

### 6. Exemplary Methods

In view of the aspects described hereinbefore, an exemplary methods that can be implemented in accordance with the disclosed subject matter can be better appreciated with reference to the flowchart in FIGS. 1-4. For purposes of simplicity of explanation, the exemplary method disclosed herein is presented and described as a series of acts; however, it is to be understood and appreciated that the claimed subject matter is not limited by the order of steps, as some steps may occur in different orders and/or concurrently with other acts from that shown and described herein. For example, the various methods or processes of the subject disclosure can alternatively be represented as a series of interrelated states or events, such as in a state diagram. Moreover, when disparate functional elements implement disparate portions of the methods or processes in the subject disclosure, an interaction diagram or a call flow can represent such methods or processes. Furthermore, not all illustrated acts may be required to implement a method in accordance with the subject disclosure. Further yet, two or more of the disclosed methods or processes can be implemented in combination with each other, to accomplish one or more features or advantages herein described. It should be further appreciated that the exemplary methods disclosed throughout the subject specification can be stored on an article of manufacture, or computer-readable medium, to facilitate transporting and transferring such methods to computers for execution, and thus implementation, by a processor or for storage in a memory

FIG. 1 illustrates an exemplary method 100 for conducting a dynamic unit-demand auction in accordance with aspects of the subject disclosure.

The exemplary method can be performed by a computer or computing device and can comprise the following steps. At step 110, receiving data indicative of a current allocation of a plurality of items to a plurality of agents, the current allocation allocating each item in the plurality of items to a first agent of the plurality of agents, and the first agent being allocated exactly one item of the plurality of items. At step 120, receiving data indicative of a current pricing of the plurality of items comprising a current pricing for each item of the plurality of items. At step 130, receiving data indicative of a current unit-demand bid of each agent of the plurality of agents. At step 140, updating the current allocation of the plurality of agents and the current pricing of the plurality of items, wherein the updating step yields an updated tentative allocation of the plurality of agents and an updated pricing of the plurality of items.

At step 150, exemplary method 100 can comprise determining if the auction has terminated. In one aspect, step 150 can include evaluating if a criterion to terminate the auction is fulfilled and. In response to the termination criterion not being fulfilled, exemplary method 100 comprises, at step 160, configuring the updated allocation of the plurality of items as the current tentative allocation of the plurality of items, and at step 170 configuring the updated pricing of the plurality of items as the current pricing of the plurality of items. After step 170, the exemplary method 100 comprises reiterating steps 110 through step 150.

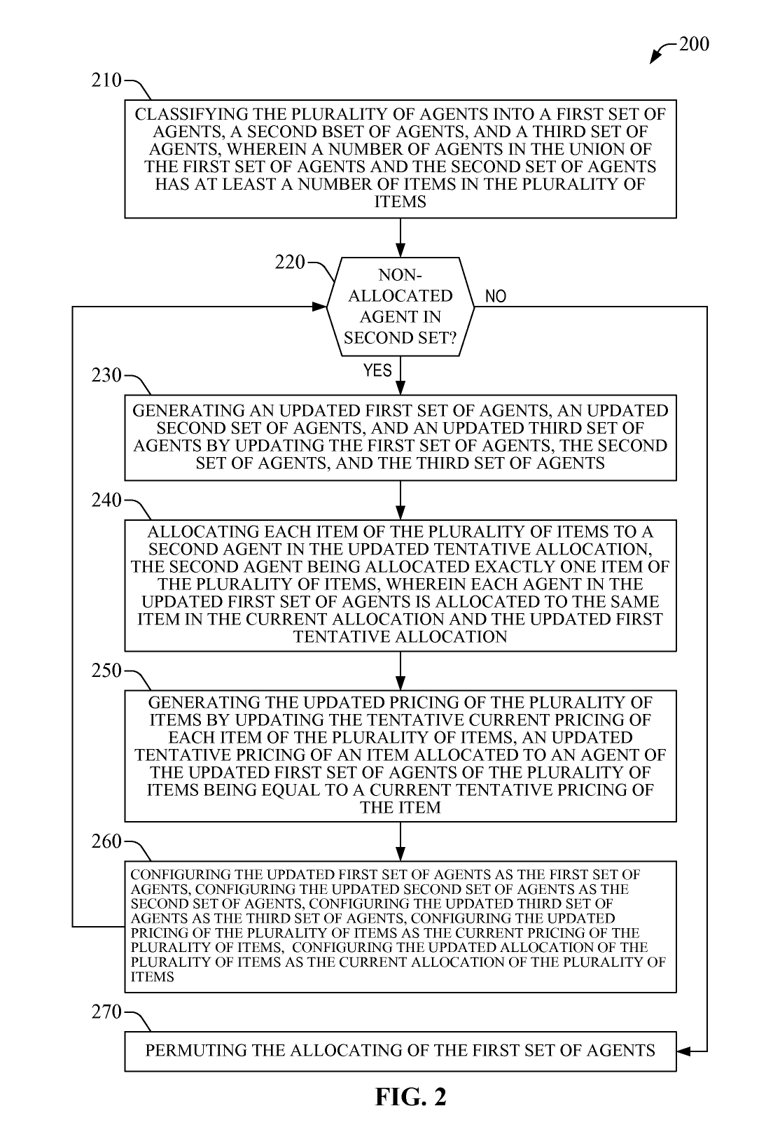

In certain embodiments, as illustrated in FIG. 2, step 140 can comprise the following. At step 210, classifying the plurality of agents into a first set of agents, a second set of agents, and a third set of agents, wherein a number of agents in the union of the first set of agents and the second set of agents has at least a number of items in the plurality of items. At step 220, determining if the second set of agents has at least one agent that is non-allocated and, in response to the second set of agents having at least one agent that is non-allocated, performing, at step 230, generating an updated first set of agents, an updated second set of agents, and an updated third set of agents by updating the first set of agents, the second set of agents, and the third set of agents; at step 240, allocating each item of the plurality of items to a second agent in the updated tentative allocation, the second agent being allocated exactly one item of the plurality of items, wherein each agent in the updated first set of agents is allocated to the same item in the current allocation and the updated first tentative allocation; at step 250, generating the updated pricing of the plurality of items by updating the tentative current pricing of each item of the plurality of items, an updated tentative pricing of an item allocated to an agent of the updated first set of agents of the plurality of items being equal to a current tentative pricing of the item; and at step 260, configuring the updated first set of agents as the first set of agents, configuring the updated second set of agents as the second set of agents, configuring the updated third set of agents as the third set of agents, configuring the updated pricing of the plurality of items as the current pricing of the plurality of items, configuring the updated allocation of the plurality of items as the current allocation of the plurality of items, and reiterating the determining step 220. In one aspect, in response to the second set of agents not having at least one agent that is non-allocated, permuting the allocating of the first set of agents is performed at step 270. In one aspect, the permuting the allocation of the first subset of agents comprises solving a house allocation problem having a homeowner for each agent in the first set of agents, wherein an initial house of an agent in the first set of agents corresponds to a unique item of the plurality of items, the unique item being allocated to the agent, and wherein the solving step comprises ranking a house according to a difference between an offer of the agent for an item of the plurality of items and a current price of the item

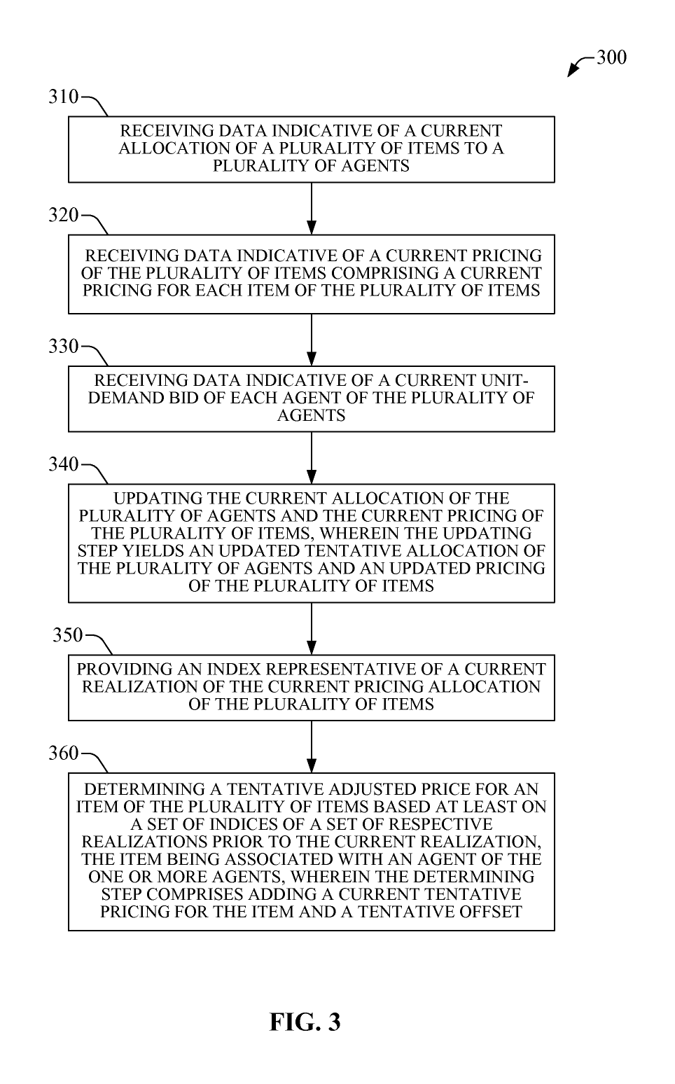

FIG. 3 illustrates an exemplary method 300 for conducting a dynamic unit-demand auction in accordance with aspects of the subject disclosure. In one aspect, steps 310 through step 340 are substantially the same as steps 110-140, and thus are not described. Exemplary method 300 comprises, at step 350, providing an index representative of a current realization of the current pricing allocation of the plurality of items and the current allocation of the plurality of items; and at step 360, determining an adjusted price for an item of the plurality of items based at least on a set of indices of a set of respective realizations prior to the current realization, the item being associated with an agent of the plurality of agents, wherein the determining step comprises adding a current tentative pricing for the item and an offset.

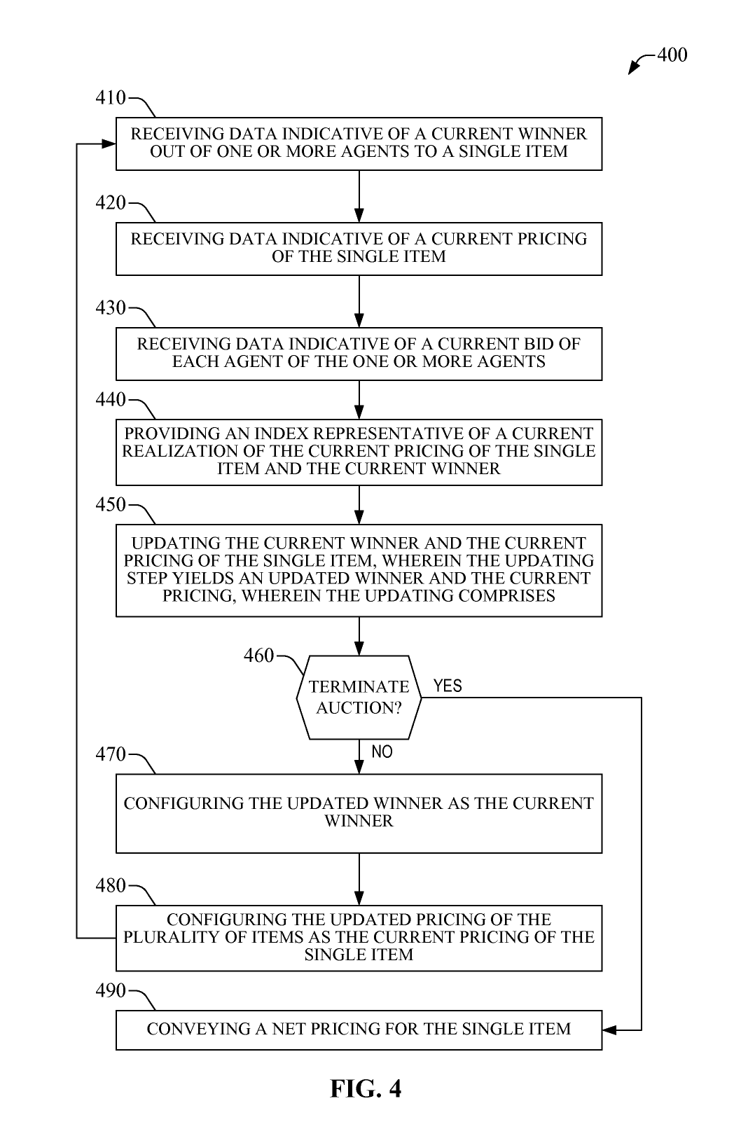

FIG. 4 illustrates a method 400 for conducting a single-item auction with dynamic pricing in accordance with aspects of the subject disclosure. Exemplary method 400 comprises, at step 410, receiving data indicative of a current winner out of one or more agents to a single item; at step 420, receiving data indicative of a current pricing of the single item; at step 430, receiving data indicative of a current bid of each agent of the one or more agents; at step 440, providing an index representative of a current realization of the current pricing of the single item and the current winner; and at step 450, updating the current winner and the current pricing of the single item, wherein the updating step yields an updated winner and the current pricing. In one aspect, the updating step comprises determining an adjusted price for the single item based at least on a set of indices of a set of respective realizations prior to the current realization, wherein the determining step comprises adding the current pricing for the single item and an offset. The exemplary method 400 also comprises the step 460 of determining if the auction has terminated. In an aspect, the determining comprises evaluating if a criterion to terminate the auction is fulfilled and, in response to the termination criterion not being fulfilled, performing, at step 470, configuring the updated winner as the current winner, and performing, at step 480, configuring the updated pricing of the plurality of items as the current pricing of the single item. Subsequent to step 480, step 410-460 are reiterated.

### 7. Exemplary System Implementation

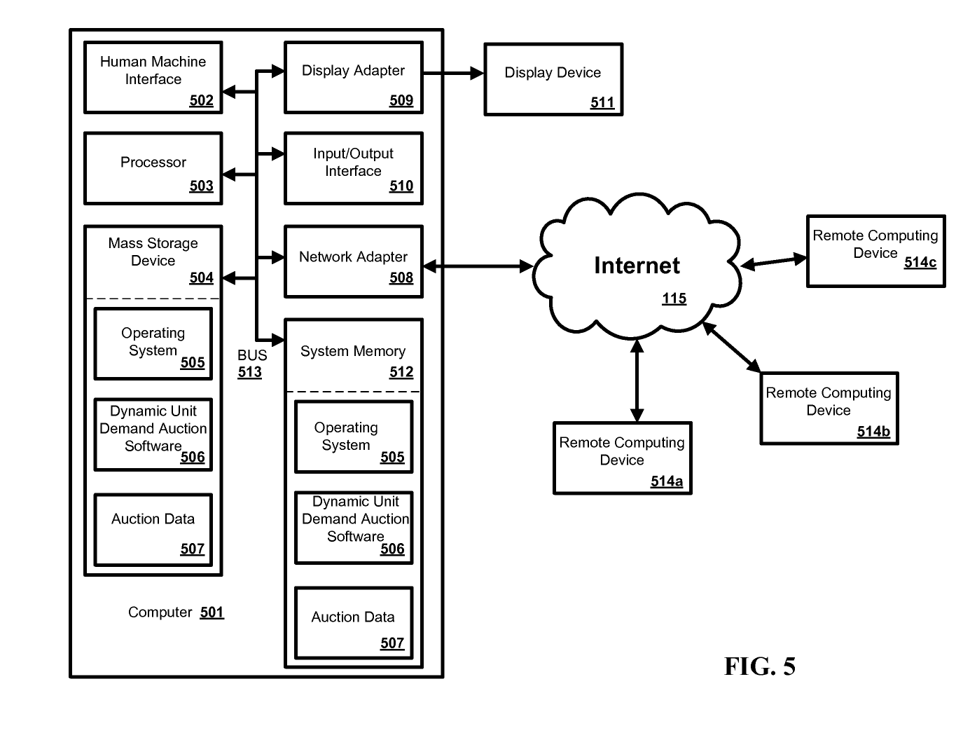

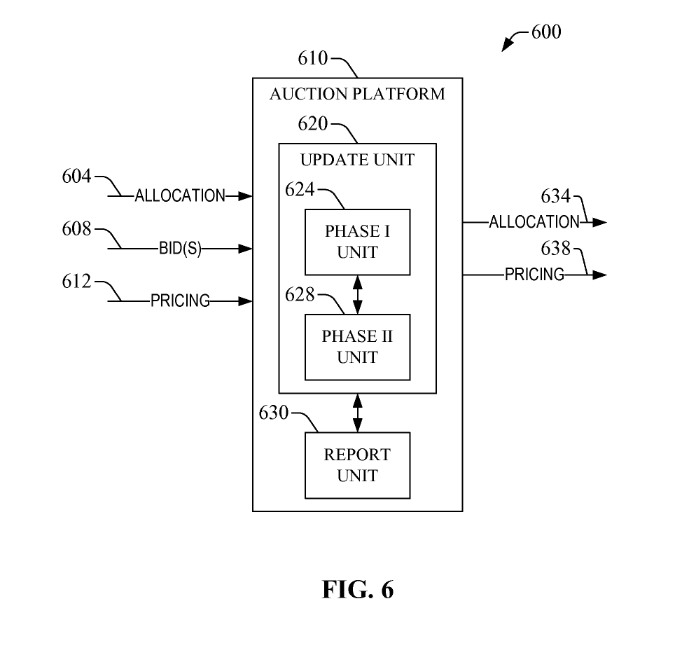

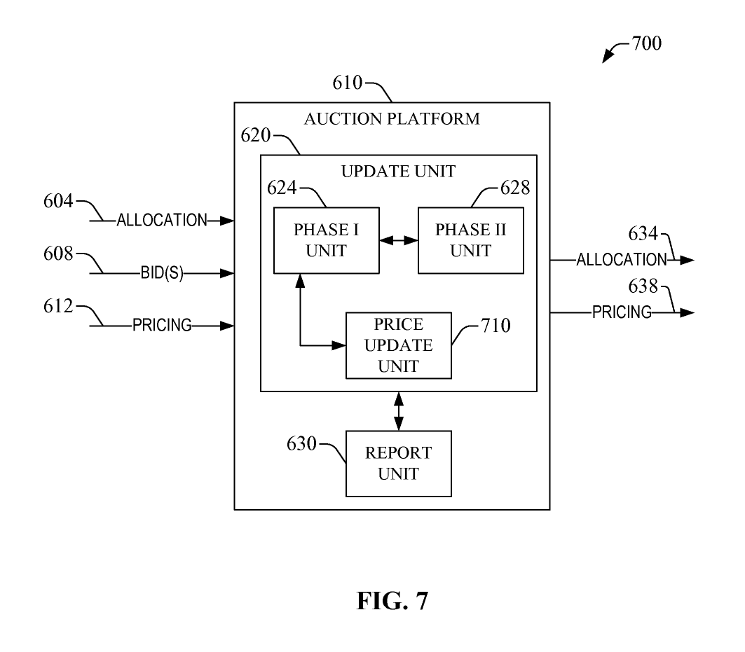

As illustrated in FIGS. 6-7, various embodiments of systems that can conduct a dynamic unit-demand auction of the subject disclosure can be described as being comprised of units. This is a functional description and that the respective functions can be performed by software, hardware, or a combination of software and hardware. A unit can be software, hardware, or a combination of software and hardware. The units can comprise the dynamic unit-demand auction software 506 as illustrated in FIG. 5 and described below. In one exemplary aspect, the units can comprise a computer 501 as illustrated in FIG. 5 and described below. The computer 501 can execute the various methods described in the subject specification (e.g., FIGS. 1-4). In addition, computer 501 can embody auction platform 610.

FIG. 5 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 501. The components of the computer 501 can comprise, but are not limited to, one or more processors or processing units 503, a system memory 512, and a system bus 513 that couples various system components including the processor 503 to the system memory 512. In the case of multiple processing units 503, the system can utilize parallel computing.

The system bus 513 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 513, and all buses specified in this description can also be implemented over a wired or wireless network connection and each of the subsystems, including the processor 503, a mass storage device 504, an operating system 505, dynamic unit-demand auction software 506, auction data 507, a network adapter 508, system memory 512, an Input/Output Interface 510, a display adapter 509, a display device 511, and a human machine interface 502, can be contained within one or more remote computing devices 514a,b,c at physically separate locations, connected through buses of this form, in effect implementing a fully distributed system. Dynamic unit-demand auction software 506 and/or auction data 507 can configure processor 503 to perform the various steps described herein. Auction data 507 can comprise data indicative of an allocation 604 of item(s) to agent(s), data indicative of a bid(s) 608 in accordance with aspects herein, and data indicative of pricing of item(s) 612, which comprises prices of one or more items. In addition auction data 507 also can comprise data indicative of an allocation 634 of item(s) to agent(s) and data indicative of pricing 638 of item(s). In one aspect, processor 503 can embody phase I unit 624, which can perform a first phase of Auction SB3. In another aspect, processor 503 can embody phase II unit 630, which can perform a second phase of Auction SB3 described herein. In yet another embodiment, processor 503 also can embody report unit 630, which can publish or otherwise convey data in accordance with aspects of the subject disclosure. Likewise, in certain embodiments (see, e.g., FIG. 7) processor 503 can embody price update unit 710, which can implement dynamic pricing in accordance with various aspects of the subject specification.

The computer 501 typically comprises a variety of computer readable media. Exemplary readable media can be any available media that is accessible by the computer 501 and comprises, for example and not meant to be limiting, both volatile and non-volatile media, removable and non-removable media. The system memory 512 comprises computer readable media in the form of volatile memory, such as random access memory (RAM), and/or non-volatile memory, such as read only memory (ROM). The system memory 512 typically contains data such as auction data 507 and/or program modules such as operating system 505 and unit-demand auction software 506 that are immediately accessible to and/or are presently operated on by the processing unit 503.

In another aspect, the computer 501 can also comprise other removable/non-removable, volatile/non-volatile computer storage media. By way of example, FIG. 5 illustrates a mass storage device 504 which can provide non-volatile storage of computer code, computer readable instructions, data structures, program modules, and other data for the computer 501. For example and not meant to be limiting, a mass storage device 504 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 504, including by way of example, an operating system 505 and unit-demand auction software 506. Each of the operating system 505 and unit-demand auction software 506 (or some combination thereof) can comprise elements of the programming and the dynamic unit-demand auction software 506. Such software can comprise one or more computer-executable code instructions which can configure processor 503 to performs steps of the various methods described herein, or to provide functionality of auction platform 610 and units therein. Auction data 507 can also be stored on the mass storage device 504. Auction data 507 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 501 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 503 via a human machine interface 502 that is coupled to the system bus 513, but can be connected by other interface and bus structures, such as a parallel port, game port, an IEEE 1394 Port (also known as a Firewire port), a serial port, or a universal serial bus (USB).

In yet another aspect, a display device 511 can also be connected to the system bus 513 via an interface, such as a display adapter 509. It is contemplated that the computer 501 can have more than one display adapter 509 and the computer 501 can have more than one display device 511. For example, a display device can be a monitor, an LCD (Liquid Crystal Display), or a projector. In addition to the display device 511, other output peripheral devices can comprise components such as speakers (not shown) and a printer (not shown) which can be connected to the computer 501 via Input/Output Interface 510. Any step and/or result of the methods can be output in any form to an output device. Such output can be any form of visual representation, including, but not limited to, textual, graphical, animation, audio, tactile, and the like.

The computer 501 can operate in a networked environment using logical connections to one or more remote computing devices 514a,b,c. By way of example, a remote computing device can be a personal computer, portable computer, a server, a router, a network computer, a peer device or other common network node, and so on. Logical connections between the computer 501 and a remote computing device 514a,b,c can be made via a local area network (LAN) and a general wide area network (WAN). Such network connections can be through a network adapter 508. A network adapter 508 can be implemented in both wired and wireless environments. Such networking environments are conventional and commonplace in offices, enterprise-wide computer networks, intranets, and the Internet 515.

For purposes of illustration, application programs and other executable program components such as the operating system 505 are illustrated herein as discrete blocks, although it is recognized that such programs and components reside at various times in different storage components of the computing device 501, and are executed by the data processor(s) of the computer. An implementation of unit-demand auction software 506 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

### 7. Exemplary Implementations

Consider an auction scenario in which a developer of a new high-rise condominium project wishes to sell a plurality of dwelling units to the public. In this scenario, an agent can be a buyer, and each buyer in a set of buyers can assign a different value to each dwelling unit of the plurality of dwelling units based at least on one or more factors such as floor plan, elevation, view, or the like. When each buyer is seeking to purchase at most one dwelling unit, the private valuations of the agents can be accurately modeled in the unit-demand model. In one aspect, a buyer who is interested in purchasing two or more dwelling units can submit multiple unit-demand bids accordingly. It should be appreciated that if the plurality of dwelling units are sold sequentially utilizing a traditional single-item auction, a buyer who is interested in purchasing a current dwelling unit being auctioned needs to guess whether it would be better to bid on the current dwelling unit, or to wait and hope to get a better deal on a dwelling unit to be auctioned later. Such guesswork generally degrades the efficiency of the auction. Selling a plurality of the dwelling units “in parallel” in a single unit-demand auction eliminates the guesswork thus affording improved efficiency.

The preceding condominium example can demonstrate one or more advantages of a unit-demand auction as described herein over a traditional sequential auction.

While certain web-based online auction sites utilize a dynamic auction format, utilization of a dynamic unit-demand auction described herein can enhance the bidding interface of such auction sites, enabling users to make unit-demand bids. Because in a unit-demand bid an agent specifies a separate offer for each of one or more items, it generally is desirable for a practical dynamic unit-demand auction system to support bid revision. In addition, it is not desirable to permit an agent to abandon a tentatively allocated unit-demand bid, as such bid revocation can force tentative prices to decrease, which in turn can degrade or invalidate certain auction properties related to truthfulness and privacy preservation that generally are desired to be maintained.

In connection with bid revision, when a bid is revised by agent u, the new bid is called the “target bid” of agent u, and a set of “admissible bids” for agent u can be defined that comprises one or more bids that are consistent with a current pricing and allocation. As additional bidding activity occurs, the set of admissible bids for agent u can only grow. In response to the target bid becoming admissible, the current bid of agent u can be set to the target bid. In one aspect, a unit-demand auction described herein can be implemented to employ a proxy agent that can automatically introduce a target bid substantially upon the possibility becomes available. Such automated feature makes bid revision convenient for an agent.

One aspect of the bid revision scheme described herein is that it satisfies strong truthfulness properties. In particular, yet not exclusively, a strategy that exploits the proxy agent is a provably optimal strategy for the agent within a single round of a dynamic unit-demand auction as described herein. Moreover, in certain embodiments, such strategy can remain optimal or nearly-optimal across arbitrarily many rounds of the dynamic unit-demand auction. Such truthfulness properties imply that it is a good strategy for an agent to simply bid truthfully and allow the proxy agent to incorporate the target bid automatically substantially upon the possibility becomes available. Conveyed in different terms, the agent is unlikely to gain any advantage by engaging in the potentially laborious process of submitting a carefully constructed sequence of non-truthful bid revision requests.

In one aspect, the dynamic unit-demand auction described herein can provide strong guarantees related to efficiency. As an example, it can be asserted that the tentative allocation is efficient with respect to the following valuations: (a) for any agent whose current bid is equal to the target bid, the associated valuation is taken to be given by the target bid; (b) for any agent whose current bid is not equal to its target bid—e.g., due to a bid revision by that agent—the associated valuation can be taken to be given by an arbitrary admissible bid. Since the set of admissible bids cannot shrink while the agent remains in category (b), the preceding invariant implies that efficiency with respect to the target bids can only improve as additional bids are processed. A second efficiency-related invariant maintained by embodiments of the described dynamic unit-demand auction is that the tentative allocation is in the weak core with respect to the target bids—no group of agents can trade their tentatively allocated items amongst themselves in a manner that all agents in the group are better off (e.g., experience an increase in utility).

Furthermore, embodiments of the described dynamic unit-demand auction also can provide strong guarantees related to privacy preservation. In one aspect, the privacy preservation property can ensure that no “shill agent” can force a price of an item up without incurring the risk of winning the item. Such property can hold even if the shill agent knows the private bid information of all agents except the one being targeted by the shill agent, and even if this target agent is not allowed to perform bid revision.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims or inventive concepts.

What is claimed is:

1. A method for performing an auction, the method comprising:
(a) receiving data indicative of a current allocation of a plurality of items to a plurality of agents, the current allocation allocating each item in the plurality of items to a first agent of the plurality of agents, and the first agent being allocated exactly one item of the plurality of items;
(b) receiving data indicative of a current pricing of the plurality of items comprising a current pricing for each item of the plurality of items;
(c) receiving data indicative of a current unit-demand bid of each agent of the plurality of agents; and
(d) updating the current allocation of the plurality of agents and the current pricing of the plurality of items, wherein the updating step yields an updated tentative allocation of the plurality of agents and an updated pricing of the plurality of items, and wherein the updating step comprises:
classifying the plurality of agents into a first set of agents, a second set of agents, and a third set of agents, wherein a number of agents in the union of the first set of agents and the second set of agents has at least a number of items in the plurality of items;
determining if the second set of agents has at least one agent that is non-allocated and,
in response to the second set of agents having at least one agent that is non-allocated, performing the steps of:
generating an updated first set of agents, an updated second set of agents, and an updated third set of agents by updating the first set of agents, the second set of agents, and the third set of agents,
allocating each item of the plurality of items to a second agent in the updated tentative allocation, the second agent being allocated exactly one item of the plurality of items, wherein each agent in the updated first set of agents is allocated to the same item in the current allocation and the updated first tentative allocation,
generating the updated pricing of the plurality of items by updating the tentative current pricing of each item of the plurality of items, an updated tentative pricing of an item allocated to an agent of the updated first set of agents of the plurality of items being equal to a current tentative pricing of the item,
configuring the updated first set of agents as the first set of agents,
configuring the updated second set of agents as the second set of agents,
configuring the updated third set of agents as the third set of agents,
configuring the updated pricing of the plurality of items as the current pricing of the plurality of items,
configuring the updated allocation of the plurality of items as the current allocation of the plurality of items, and
reiterating the determining step, and
in response to the second set of agents not having at least one agent that is non-allocated, permuting the allocating of the first set of agents.

2. The method of claim 1, further comprising the step of:
(e) evaluating if a criterion to terminate the auction is fulfilled and, in response to the termination criterion not being fulfilled, performing the steps of:
configuring the updated allocation of the plurality of items as the current tentative allocation of the plurality of items, and
configuring the updated pricing of the plurality of items as the current pricing of the plurality of items.

3. The method of claim 2, further comprising reiterating steps (a) through step (e).

4. The method of claim 2, further comprising publishing at least one of the current allocation of the plurality of agents to the plurality of items.

5. The method of claim 2, further comprising, in response to the criterion to terminate the auction being fulfilled, conveying at least one of the current tentative allocation of the plurality of agents or the current pricing of the plurality of items.

6. The method of claim 1, wherein updating the first set of agents, the second set of agents, and the third set of agents comprises:
selecting a non-allocated agent in the second set of agents;
generating a subset of the plurality of agents comprising the non-allocated agent, each allocated agent in the first set of agents, and each allocated agent in the second set of agents; and
ranking each agent in the subset of the plurality of agents, each agent having a unique identifier drawn from a totally ordered set, wherein the ranking step yields an ordering of the subset of the plurality of agents based at least on respective unique identifiers.

7. The method of claim 6, further comprising:
preserving a current unit-demand bid of an agent in the second set of agents; and
replacing a current unit-demand bid of an agent in the first set for each agent in the second set of agents, wherein the replacing step comprises exchanging the current unit-demand bid for a delta bid on an item of the plurality of items, the item being allocated to the agent and the delta bid being equal to a tentative price of the item, and wherein the delta bid on the item is a unit-demand bid having a single offered amount for the item equal to the current price of the item.

8. The method of claim 7, further comprising:
generating an allocation of the subset of the plurality of agents for the plurality of items; and
generating a pricing of the plurality of items based at least on the allocation.

9. The method of claim 8, wherein the generating step comprises computing one or more maximum-weight maximum-cardinality matchings (MWMCMs) of a complete edge-weighted bipartite graph having nodes on a first side of the bipartite graph that correspond to the subset of the plurality of agents, and having nodes on a second side of the bipartite graph that correspond to the plurality of items, and wherein a weight of an edge in the complete edge-weighted bipartite graph from an agent to an item is equal to an offer of the agent for the item.

10. The method of claim 9, wherein the generating step further comprises restricting a tuple associated with an MWMCM of the one or more MWMCMs to being lexicographically maximum over the one or more MWMCMs, where the tuple is indicative of a group of allocated agents in the subset of the plurality of agents.

11. The method of claim 6, wherein the ranking step comprises assigning to each agent in the second set of agents a rank that is higher than a rank of an agent in the first subset of agents.

12. The method of claim 1, wherein permuting the allocation of the first subset of agents comprises solving a house allocation problem having a homeowner for each agent in the first set of agents, wherein an initial house of an agent in the first set of agents corresponds to a unique item of the plurality of items, the unique item being allocated to the agent, and wherein the solving step comprises ranking a house according to a difference between an offer of the agent for an item of the plurality of items and a current price of the item.

13. The method of claim 1, wherein the generating step comprises:
transitioning a first agent from the first set of agents to at least one of the second set of agents or the third set of agents, a second agent from the second set of agents to the third set of agents; and
excluding transitioning a third agent from the second set of agents to the first set of agents, and a fourth agent from the third set of agents to at least one of the first set of agents or the second set of agents.

14. The method of claim 1, wherein updating the tentative current pricing of each item of the plurality of items yields an updated tentative pricing of each item of the plurality of items being at least equal to a current tentative pricing of the respective item.

15. The method of claim 1, wherein allocating each item of the plurality of items to the second agent in the updated tentative allocation comprises permitting at most one agent that is allocated in the current tentative allocation to become non-allocated in the updated tentative allocation.

16. The method of claim 1, wherein the updating step further comprises maintaining an envy-free condition of an agent of the plurality of agents, the agent being envy-free agent prior to the updating step, and wherein an envy-free condition is fulfilled when a gap of the agent is non-negative, and for each item of the plurality of items, the gap of the agent is at least as large as a difference between an offer for the item the current unit demand bid of the agent and a current pricing of the item.

17. The method of claim 1, wherein each agent of the first set of agents is allocated in the current tentative allocation, and wherein each allocated agent of the second set of agents that is allocated in the current tentative allocation is envy-free, and further wherein each agent in the third set of agents is envy-free and is non-allocated.

18. The method of claim 2, further comprising:
providing an index representative of a current realization of the current pricing allocation of the plurality of items and the current allocation of the plurality of items;
determining an adjusted price for an item of the plurality of items based at least on a set of indices of a set of respective realizations prior to the current realization, the item being associated with an agent of the plurality of agents, wherein the determining step comprises adding a current tentative pricing for the item and an offset.

19. The method of claim 18, wherein the determining step further comprises determining the tentative offset based on a set of adjustment functions defined for each index in the set of indices and an adjustment rule, wherein an adjustment function provides a value indicative of an offset for an agent-item pair, and wherein and adjustment rule specifies an adjustment index greater than unity and less than or equal to the index of the current realization.

20. The method of claim 19, further comprising, in response to the criterion to terminate the auction being fulfilled, conveying a net pricing for the item, the net pricing resulting from the determining step.

21. A method for performing a single-item auction, the method comprising:
(a) receiving data indicative of a current winner out of one or more agents to a single item;
(b) receiving data indicative of a current pricing of the single item;
(c) receiving data indicative of a current bid of each agent of the one or more agents;
(d) providing an index representative of a current realization of the current pricing of the single item and the current winner; and
(e) updating the current winner and the current pricing of the single item, wherein the updating step yields an updated winner and the current pricing, wherein the updating comprises:
determining an adjusted price for the single item based at least on a set of indices of a set of respective realizations prior to the current realization, wherein the determining step comprises adding the current pricing for the single item and an offset.

22. The method of claim 21, further comprising the step of:
(f) evaluating if a criterion to terminate the auction is fulfilled and, in response to the termination criterion not being fulfilled, performing the steps of:
configuring the updated winner as the current winner, and
configuring the updated pricing of the plurality of items as the current pricing of the single item.

23. The method of claim 22, further comprising reiterating steps (a) through step (f).

24. The method of claim 23, wherein the determining step further comprises determining the tentative offset based on a set of adjustment functions defined for each index in the set of indices and an adjustment rule, wherein an adjustment function provides a value indicative of an offset for an agent, and wherein an adjustment rule specifies an adjustment index greater than unity and less than or equal to the index of the current realization

25. The method of claim 21, further comprising, in response to the criterion to terminate the auction being fulfilled, conveying a net pricing for the single item, the net pricing resulting from the adding step.

26. A system, comprising:
a memory comprising at least one computer-executable instructions; and
a processor functionally coupled to the memory and configured by the at least one computer-executable instructions to perform the steps of:
(a) receiving data indicative of a current allocation of a plurality of items to a plurality of agents, the current allocation allocating each item in the plurality of items to a first agent of the plurality of agents, and the first agent being allocated exactly one item of the plurality of items;
(b) receiving data indicative of a current pricing of the plurality of items comprising a current pricing for each item of the plurality of items;
(c) receiving data indicative of a current unit-demand bid of each agent of the plurality of agents; and
(d) updating the current allocation of the plurality of agents and the current pricing of the plurality of items, wherein the updating step yields an updated tentative allocation of the plurality of agents and an updated pricing of the plurality of items, and wherein the updating step comprises:
classifying the plurality of agents into a first set of agents, a second set of agents, and a third set of agents, wherein a number of agents in the union of the first set of agents and the second set of agents has at least a number of items in the plurality of items;
determining if the second set of agents has at least one agent that is non-allocated and,
in response to the second set of agents having at least one agent that is non-allocated, performing the steps of:
generating an updated first set of agents, an updated second set of agents, and an updated third set of agents by updating the first set of agents, the second set of agents, and the third set of agents,
allocating each item of the plurality of items to a second agent in the updated tentative allocation, the second agent being allocated exactly one item of the plurality of items, wherein each agent in the updated first set of agents is allocated to the same item in the current allocation and the updated first tentative allocation,
generating the updated pricing of the plurality of items by updating the tentative current pricing of each item of the plurality of items, an updated tentative pricing of an item allocated to an agent of the updated first set of agents of the plurality of items being equal to a current tentative pricing of the item,
configuring the updated first set of agents as the first set of agents,
configuring the updated second set of agents as the second set of agents,
configuring the updated third set of agents as the third set of agents,
configuring the updated pricing of the plurality of items as the current pricing of the plurality of items,
configuring the updated allocation of the plurality of items as the current allocation of the plurality of items, and
reiterating the determining step, and
in response to the second set of agents not having at least one agent that is non-allocated, permuting the allocating of the first set of agents.

27. The system of claim 26, wherein the processor is further configured by the at least one computer-executable instructions to perform the steps of:
(e) evaluating if a criterion to terminate the auction is fulfilled and, in response to the termination criterion not being fulfilled, performing the steps of:
configuring the updated allocation of the plurality of items as the current tentative allocation of the plurality of items, and
configuring the updated pricing of the plurality of items as the current pricing of the plurality of items.

28. The system of claim 26, wherein the processor is further configured by the at least one computer-executable instruction to perform the step of:
reiterating steps (a) through step (e).
